(19) United States
(12) Patent Application Publication
(10) Pub. No.: US 2013/0164622 A1
(43) Pub. Date: Jun. 27, 2013

(54) POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(71) Applicants: Han-Eol Park, Yongin-si (KR); Sang-In Park, Yongin-si (KR); Ki-Hyun Kim, Yongin-si (KR); Ji-Hyun Kim, Yongin-si (KR); Jay-Hyok Song, Yongin-si (KR); Yong-Chan You, Yongin-si (KR); Ha-Young Lee, Yongin-si (KR)

(72) Inventors: Han-Eol Park, Yongin-si (KR); Sang-In Park, Yongin-si (KR); Ki-Hyun Kim, Yongin-si (KR); Ji-Hyun Kim, Yongin-si (KR); Jay-Hyok Song, Yongin-si (KR); Yong-Chan You, Yongin-si (KR); Ha-Young Lee, Yongin-si (KR)

(21) Appl. No.: 13/584,692

(22) Filed: Aug. 13, 2012

Related U.S. Application Data
(60) Provisional application No. 61/579,869, filed on Dec. 23, 2011.

(51) Int. Cl. H01M 4/58; H01M 4/505; H01M 4/583; H01M 4/485; H01M 4/525; B82Y 30/00

(52) U.S. Cl. 429/221; 429/231.2; 429/231.3; 429/223; 429/224; 252/182.1; 252/519.14; 252/506; 977/742; 977/773; 977/948; 977/762

(57) ABSTRACT

A positive active material for a rechargeable lithium battery including a compound represented by the following Chemical Formula 1:

LiₓM_{y}Co_{z}PO₄ Chemical Formula 1

wherein 0≦x≦2, 0.98≦y≦1, 0<z≦0.02, M is selected from the group consisting of V, Mn, Fe, Ni, and combinations thereof, and the compound exhibits a peak at a 2θ value in a range of 40.0 degrees to 41.0 degrees in an X-ray diffraction pattern measured using CuKα radiation, is disclosed.

### CROSS-REFERENCE TO RELATED APPLICATION

This application claims priority to and the benefit of U.S. Provisional Application No. 61/579,869, filed on Dec. 23, 2011, in the USPTO, the disclosure of which is incorporated herein in its entirety by reference

### BACKGROUND

(a) Field

Aspects of embodiments of the present invention are directed toward a positive active material for a rechargeable lithium battery, a method of preparing the same, and a rechargeable lithium battery including the same.

(b) Description of the Related Art

Batteries generate electric power using an electrochemical reaction material for a positive electrode and a negative electrode. Lithium rechargeable batteries generate electrical energy from changes of chemical potential during the intercalation/deintercalation of lithium ions at the positive and negative electrodes.

Lithium rechargeable batteries use materials that reversibly intercalate or deintercalate lithium ions during charge and discharge reactions for both positive and negative active materials and contain an organic electrolyte or a polymer electrolyte between the positive electrode and the negative electrode.

As for negative active materials for rechargeable lithium batteries, various carbon-based materials such as artificial graphite, natural graphite, and hard carbon, which can all intercalate and deintercalate lithium ions, have been used.

For positive active materials for rechargeable lithium batteries, lithium-transition element composite oxides being capable of intercalating lithium such as LiCoO₂, LiMn₂O₄, LiNiO₂, LiNi₁₋ₓCoₓO₂ (0<x<1), LiMnO₂, LiFePO₄, and the like have been researched.

### SUMMARY

An aspect of an embodiment of the present invention is directed toward a positive active material that can improve charge and discharge capacity and high-rate characteristics.

An aspect of an embodiment of the present invention is directed toward a method of preparing the positive active material.

An aspect of an embodiment of the present invention is directed toward a rechargeable lithium battery including the positive active material.

According to an embodiment of the present invention, a positive active material for a rechargeable lithium battery includes a compound according to Chemical Formula 1:

LiₓM_{y}Co_{z}PO₄ Chemical Formula 1

wherein 0≦x≦2, 0.98≦y≦1, 0<z≦0.02, M is selected from the group consisting of V, Mn, Fe, Ni, and combinations thereof, and the compound exhibits a peak at a 2θ value of 40.0 degrees to 41.0 degrees in an X-ray diffraction (XRD) pattern measured using CuKα radiation.

The positive active material for a rechargeable lithium battery may exhibit a peak at a (002) plane in the X-ray diffraction pattern and a peak at a (020) plane in the X-ray diffraction pattern, the peak at the (020) plane and the peak at the (002) plane having an intensity ratio in a range of 20:1 to 8:1.

The positive active material for a rechargeable lithium battery may have an average particle diameter in a range of 100 to 800 nm.

The positive active material for a rechargeable lithium battery may further include a carbon coating layer on at least a portion of the compound.

The carbon coating layer may include a carbon material selected from the group consisting of carbon nanotubes, carbon nanorods, carbon nanowires, denka black, ketjen black, and combinations thereof.

The positive active material for a rechargeable lithium battery may have an electrical conductivity in a range of 10⁻⁴² to 10⁻¹ S/m and an ion conductivity in a range of 10⁻¹⁰ to 10⁻¹ S/m.

According to another embodiment of the present invention, provided is a method of preparing a positive active material for a rechargeable lithium battery, the method including: mixing a Li raw material, an M raw material, a PO₄ raw material, and a Co raw material; and heat-treating the resultant mixture at a temperature in a range of 650 to 850° C. to prepare a compound according to chemical formula 1.

LiₓM_{y}Co_{z}PO₄ Chemical Formula 1

wherein 0≦x≦2, 0.98≦y≦1, 0<z≦0.02, and M is selected from the group consisting of V, Mn, Fe, Ni, and combinations thereof.

The heat-treating may include increasing the temperature at a rate of 2° C./min.

The heat-treating may be performed for 10 hours.

The method may further include cooling the compound.

The cooling may decreasing the temperature at a rate of 2° C./min.

The method may further include adding a carbon raw material to the resultant mixture prior to the heat-treating.

The carbon raw material may be selected from the group consisting of sucrose, glycol, glycerin, kerosene, and combinations thereof.

The heat-treating may be performed as a single step.

According to another embodiment of the present invention, provided is a rechargeable lithium battery that includes a positive electrode including the positive active material; a negative electrode including a negative active material; and an electrolyte.

The positive active material for a rechargeable lithium battery has improved electrical conductivity and ion conductivity as well as stability and economical characteristics of an olivine structure and thus, realizes a rechargeable lithium battery with excellent cycle-life characteristic, initial charge and discharge capacity and high-rate characteristics.

### BRIEF DESCRIPTION OF THE DRAWINGS

The accompanying drawings, together with the specification, illustrate exemplary embodiments of the present invention, and, together with the description, serve to explain the principle of the present invention.

FIG. 1 is a schematic view of a rechargeable lithium battery according to one embodiment of the present invention.

FIG. 2 is a graph showing the XRD data of a positive active material for a rechargeable lithium battery according to an exemplary embodiment of the present invention.

FIG. 3 is a graph showing the XRD data of a positive active material for a rechargeable lithium battery according to another exemplary embodiment of the present invention.

FIG. 4 is a graph showing the XRD data of a positive active material for a rechargeable lithium battery according to a Comparative Example.

FIGS. 5A through 5B show XRD data of each a, b, and c axis direction extracted from the XRD data of FIGS. 2 to 4.

FIGS. 6A through 6C show charge and discharge data of rechargeable lithium batteries according to exemplary embodiments of the present invention, and a Comparative Example, respectively.

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

Aspects of embodiments of the present invention are directed toward a positive active material for a rechargeable lithium battery represented by the following Chemical Formula 1:

LiₓM_{y}Co_{z}PO₄ Chemical Formula 1

wherein 0≦x≦2, 0.98≦y≦1, 0<z≦0.02, M is selected from the group consisting of V, Mn, Fe, Ni, and combinations thereof, and the compound exhibits a peak at a 2 θ value in a range of 40.0 degrees to 41.0 degrees in an X-ray diffraction (XRD) pattern measured using CuKα radiation.

The positive active material represented by the above Chemical Formula 1 has an olivine structure, in which the transition elements of M may be partly substituted with Co. The positive active material represented by the above Chemical Formula 1 is prepared through a one step heat-treatment and has an olivine structure with different crystal degree and surface state from olivine structures prepared through multi-step heat-treatments. As a result, the positive active material has improved electrical conductivity and ion conductivity and, thus, improved initial capacity of a rechargeable battery that includes the positive active material. Additionally, the positive active material still maintains an olivine structure and, thus, has economical and stable high voltage characteristics due to the olivine structure. A method including the heat treatment for preparing the positive active material is described below.

The positive active material for a rechargeable lithium battery has a peak at 2θ value in a range of about 40.0 degrees to about 41.0 degrees in an X-ray diffraction (XRD) pattern using CuKα ray due to its crystal degree and surface state changes of its olivine structure.

In addition, the positive active material for a rechargeable lithium battery may exhibit a peak at a (002) plane in the XRD pattern and a peak at a (020) plane in the XRD pattern, the peak at the (020) plane and the peak at the (002) plane having an intensity ratio in a range of about 20:1 to about 8:1.

The positive active material for a rechargeable lithium battery may have a particle size in a range of about 100 nm to about 800 nm.

In one embodiment, the positive active material with a particle size within this range has improved electrical conductivity.

In the above Chemical Formula 1, the doping amount of cobalt is determined depending on z, for example, 0.01≦z≦0.02. In one embodiment, when cobalt is doped within this range, the positive active material has improved electrical conductivity and ion conductivity.

The positive active material for a rechargeable lithium battery may further include a carbon coating layer on the surface (e.g., on at least a portion of the surface). The positive active material for a rechargeable lithium battery including the carbon coating layer may have improved electrical conductivity and, thus, excellent electrochemical characteristics.

The carbon coating layer may have a thickness in a range of about 5 nm to about 100 nm. In one embodiment, when the carbon coating layer has a thickness within this range, it effectively improves the electrical conductivity of the positive active material.

The carbon coating layer may include, for example, a carbon material selected from the group consisting of carbon nanotubes, carbon nanorods, carbon nanowires, denka black, ketjen black, or combinations thereof.

The positive active material for a rechargeable lithium battery may have, for example, electrical conductivity in a range of about 10⁻⁴² to about 10⁻¹ S/m. The positive active material for a rechargeable lithium battery may have, for example, ion conductivity in a range of about 10⁻¹° to about 10⁻¹ S/m. A rechargeable lithium battery including a positive active material with electrical conductivity or ion conductivity within these ranges may have excellent initial charge and discharge capacity, and high-rate characteristics.

Hereinafter, a method of preparing the positive active material for a rechargeable lithium battery will be described.

The positive active material for a rechargeable lithium battery is prepared by mixing a Li raw material, an M raw material, a PO₄ raw material, and a Co raw material and heat-treating the resultant mixture at a temperature in a range of 650 to 850° C.

The Li raw material may include lithium phosphate (Li₃PO₄), lithium nitrate (LiNO₃), lithium acetate (LiCOOCH₃), lithium carbonate (Li₂CO₃), lithium hydroxide (LiOH), lithium dihydrogen phosphate (LiH₂PO₄), or a combination thereof, but it is not limited thereto.

The M raw material may include a raw material selected from the group consisting of metal sulfates, metal nitrates, metal acetates, metal hydroxides, metal chlorides, metal oxalates, metal fluorides, metal carbonates, and combinations thereof, (wherein the metal is selected from the group consisting of V, Mn, Fe, Ni, and combinations thereof), but it is not limited thereto.

The PO₄ raw material may include phosphoric acid (H₃PO₄), ammonium phosphate dibasic ((NH₄)₂PO₄), ammonium phosphate trihydrate ((NH₄)₃PO₄.3H₂O), metaphosphoric acid, orthophosphoric acid, ammonium dihydrogen phosphate (NH₄H₂PO₄), or a combination thereof, but it is not limited thereto.

The heat-treating (e.g., firing) may be performed as one step rather than multiple steps as described above.

For example, the heat-treating may include increasing the temperature at a rate of about 2° C./min.

The heat-treating (e.g., firing) may be performed at a temperature in a range of about 650 to about 850° C. for about 10 hours.

In addition, after the heat-treating process, a cooling process may be performed. For example, the cooling process may be performed at a rate of about 2° C./min.

The positive active material for a rechargeable lithium battery includes a compound having an olivine structure. The olivine structure may have appropriate crystal degree and surface state for achieving improved electrical conductivity and ion conductivity for the positive active material.

A carbon raw material may be added to the Li raw material, the M raw material, the PO₄ raw material, and the Co raw material (e.g., the resultant mixture) to further form a carbon coating layer on the surface.

The carbon raw material may be selected from the group consisting of sucrose, glycol, glycerin, kerosene, and combinations thereof.

In another embodiment of the present invention, a rechargeable lithium battery including a positive electrode including the positive active material; a negative electrode including a negative active material; and an electrolyte (e.g., a non-aqueous electrolyte) is provided.

A rechargeable lithium battery may be classified as a lithium ion battery, a lithium ion polymer battery, and a lithium polymer battery according to the presence of a separator and the kind of electrolyte used therein. The rechargeable lithium battery may have a variety of shapes and sizes and thus, may include a cylindrical, prismatic, coin, or pouch-type battery and a thin film type or a bulky type in size. The structure and methods of fabricating a lithium ion battery pertaining to the present invention are well known in the art.

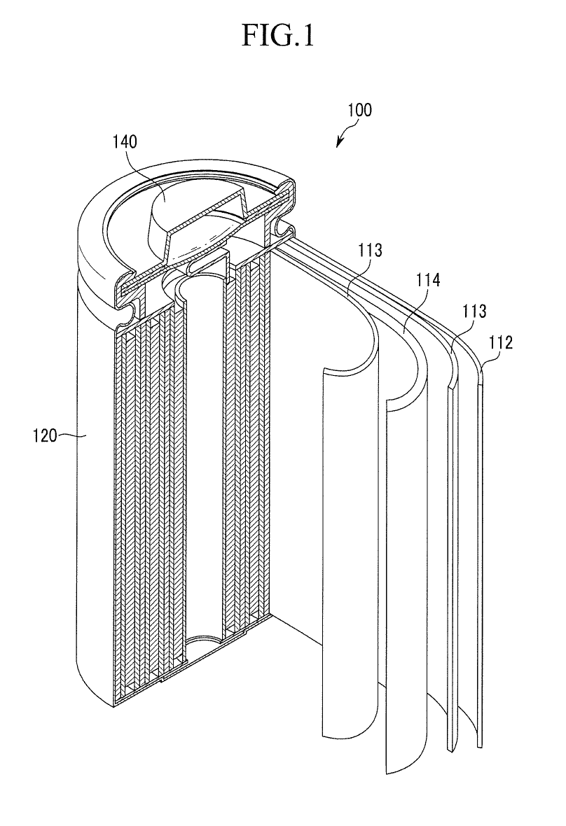

FIG. 1 is an exploded perspective view showing the schematic structure of a rechargeable lithium battery. Referring to FIG. 1, the rechargeable lithium battery 100 includes a negative electrode 112, a positive electrode 114, a separator 113 interposed between the negative electrode 112 and the positive electrode 114, an electrolyte impregnating the negative electrode 112, positive electrode 114, and separator 113, a battery case 120, and a sealing member 140 sealing the battery case 120. The rechargeable lithium battery 100 is fabricated by sequentially laminating the negative electrode 112, the positive electrode 114, and the separator 113, spirally winding them, and housing the spiral-wound product in the battery case 120.

The negative electrode includes a current collector and a negative active material layer disposed on the current collector. The negative active material layer may include a negative active material.

The negative active material includes a material that reversibly intercalates/deintercalates lithium ions, a lithium metal, a lithium metal alloy, a material being capable of doping and dedoping lithium, or a transition metal oxide.

In one embodiment, the material that can reversibly intercalate/deintercalate lithium ions includes a carbon material. The carbon material may be any carbon-based negative active material generally used for lithium ion rechargeable batteries.

Examples of the carbon material include crystalline carbon, amorphous carbon, and mixtures thereof. The crystalline carbon may be non-shaped, or sheet, flake, spherical, or fiber-shaped natural graphite or artificial graphite. The amorphous carbon may be a soft carbon (carbon fired at low temperature), a hard carbon, a mesophase pitch carbonized product, fired coke, and the like.

The lithium metal alloy may include lithium and a metal of Na, K, Rb, Cs, Fr, Be, Mg, Ca, Sr, Si, Sb, Pb, In, Zn, Ba, Ra, Ge, Al, or Sn.

In one embodiment, the material being capable of doping lithium includes Si, SiOₓ (0<x<2), a Si—C composite, a Si-Q alloy (wherein Q is selected from the group consisting of alkali metals, alkaline-earth metals, group 13 to 16 elements, transition elements, rare earth elements, and combinations thereof, with the proviso that Q is not Si), Sn, SnO₂, a Sn—C composite, a Sn—R alloy (wherein R is selected from the group consisting of alkali metals, alkaline-earth metals, group 13 to 16 elements, transition elements, rare earth elements, and combinations thereof, with the proviso that R is not Sn), and the like. The Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In one embodiment, the transition metal oxide includes vanadium oxide, lithium vanadium oxide, and the like.

The negative active material layer includes a binder and optionally, a conductive material.

The binder improves binding properties of negative active material particles with one another and with a current collector. Examples of the binder include at least one selected from polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but it is not limited thereto.

The conductive material improves electrical conductivity of the negative electrode. Any electrically conductive material can be used as a conductive agent, unless it causes a chemical change. Examples of the conductive material include at least one selected from a carbon-based material such as natural graphite, artificial graphite, carbon black, acetylene black, ketjen black, carbon fiber, and the like; a metal-based material of a metal powder or a metal fiber including copper, nickel, aluminum, silver or the like; a conductive polymer such as a polyphenylene derivative, and the like; or a mixture thereof.

In one embodiment, the current collector includes a copper foil, a nickel foil, a stainless steel foil, a titanium foil, a nickel foam, a copper foam, a polymer substrate coated with a conductive metal, or a combination thereof.

The positive electrode may include a current collector and a positive active material layer formed on the current collector.

In an exemplary embodiment of the present invention, the positive active material is the same as described above.

The positive active material layer includes the positive active material, a binder and a conductive material.

The binder improves binding properties of the positive active material particles to one another and to the current collector. Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of the positive electrode. Any electrically conductive material can be used as a conductive agent unless it causes a chemical change. Examples of the conductive material include at least one selected from the group consisting of natural graphite, artificial graphite, carbon black, acetylene black, ketjen black, carbon fiber, metal powder, metal fiber of copper, nickel, aluminum, silver, and the like, a polyphenylene derivative and combinations thereof.

The current collector may be Al but is not limited thereto.

The negative and positive electrodes may be fabricated in a method of preparing an active material composition by mixing the active material, a conductive material, and a binder and coating the composition on a current collector. The electrode manufacturing method is well known and, thus, is not described in detail in the present specification. In one embodiment, the solvent includes N-methylpyrrolidone and the like but is not limited thereto.

The electrolyte may include a non-aqueous organic solvent and a lithium salt.

The non-aqueous organic solvent plays a role of transmitting ions taking part in the electrochemical reaction of a battery.

The non-aqueous organic solvent may include a carbonate-based, ester-based, ether-based, ketone-based, alcohol-based, or aprotic solvent but it is not limited thereto. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, dimethylacetate, methylpropionate, ethylpropionate, ⊖-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran and the like. The ketone-based solvent may include cyclohexanone, and the like. The alcohol-based solvent may include ethanol, isopropylalcohol, and the like. The aprotic solvent may include nitriles such as R—CN (wherein R is a C2 to C20 linear, branched, or cyclic hydrocarbon group, and may include a double bond, an aromatic ring, or an ether bond), amides such as dimethylformamide, dimethylacetamide, dioxolanes such as 1,3-dioxolane, sulfolanes, and the like.

The non-aqueous organic solvent may be used singularly or in a mixture. When the organic solvent is used in a mixture, its mixture ratio can be controlled in accordance with desirable performance of a battery.

The carbonate-based solvent may include a mixture of a cyclic carbonate and a linear carbonate. In one embodiment, the cyclic carbonate and the linear carbonate are mixed together in a volume ratio of about 1:1 to about 1:9 as an electrolyte, so that the electrolyte can have enhanced performance.

The electrolyte may be prepared by further adding the aromatic hydrocarbon-based solvent to the carbonate-based solvent. In one embodiment, the carbonate-based solvent and the aromatic hydrocarbon-based solvent are mixed together in a volume ratio of about 1:1 to about 30:1.

The aromatic hydrocarbon-based organic solvent may be an aromatic hydrocarbon-based compound represented by the following Chemical Formula 2.

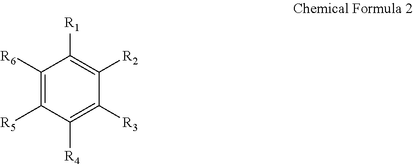

In Chemical Formula 2, R₁ to R₆ are each independently hydrogen, halogen, a C1 to 010 alkyl group, a C1 to C10 haloalkyl group, or a combination thereof.

The aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate or an ethylene carbonate-based compound represented by the following Chemical Formula 3 in order to improve cycle-life of a battery.

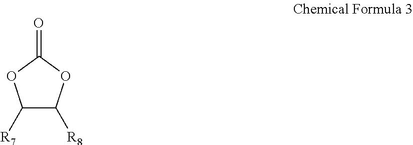

In Chemical Formula 3, R₇ and R₈ are each independently hydrogen, a halogen, a cyano group (CN), a nitro group (NO₂) or a C1 to C5 fluoroalkyl group, provided that at least one of R₇ and R₈ is a halogen, a cyano group (CN), a nitro group (NO₂) or a C1 to C5 fluoroalkyl group.

In one embodiment, the ethylene carbonate-based compound includes difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used for improving cycle life may be adjusted within an appropriate range.

The lithium salt is dissolved in the non-aqueous solvent and supplies lithium ions in a rechargeable lithium battery, and basically operates the rechargeable lithium battery and improves lithium ion transfer between positive and negative electrodes. The lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato) borate, LiBOB), or a combination thereof, which is used as a supporting electrolytic salt. The lithium salt may be used in a concentration of 0.1 to 2.0 M. In one embodiment, when the lithium salt is included within the above concentration range, the electrolyte performance and lithium ion mobility are enhanced due to improved electrolyte conductivity and viscosity.

The rechargeable lithium battery may further include a separator between the negative electrode and the positive electrode. In one embodiment, the separator includes polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, should not in any sense be interpreted as limiting the scope of the present invention.

### EXAMPLE

### Example 1

### Preparation of Positive Active Material

Lithium (Li) carbonate as a Li raw material, iron (Fe) oxalate as a Fe raw material, diammonium phosphate as a PO₄ raw material, and cobalt (Co) nitrate as a Co material were processed in a ball mill. The Co raw material and the Fe raw material were mixed in a mole ratio of 0.99:0.01 between Fe and Co atoms included in the raw materials.

The ball mill process was performed for greater than or equal to 48 hours using organic alcohol.

After the ball mill process, the simply-mixed raw materials were heated at about 100° C. under a nitrogen atmosphere or air atmosphere to evaporate the remaining organic alcohol.

After the drying, less than or equal to 5 wt % of sucrose was added to the reactant to coat carbon on the surface thereof.

Then, the reactant was heat-treated at about 700° C. for about 10 hours under a reduction atmosphere, to obtain a positive active material having an average particle diameter of 200 nm and represented by LiFe_{0.99}Co_{0.01}PO₄.

### Example 2

### Preparation of Positive Active Material

Lithium carbonate as a Li raw material, iron oxalate as a Fe raw material, diammonium phosphate as a PO₄ raw material, and Co nitrate as a Co material were processed in a ball mill. The Co raw material and the Fe raw material were mixed in a mole ratio of 0.99:0.01 between Fe and Co atoms therein.

The ball mill process was performed for greater than or equal to 48 hours using organic alcohol.

After the ball mill process, the simply-mixed raw materials were dried at about 100° C. under a nitrogen atmosphere or air atmosphere to evaporate the remaining organic alcohol.

After the drying process, less than or equal to 5 wt % of sucrose was added to the reactant to coat carbon on the surface thereof.

Then, the reactant was heat-treated at about 800° C. for about 10 hours under a reducing atmosphere, to obtain a positive active material having an average particle diameter of 400 nm and represented by LiFe_{0.99}Co_{0.01} PO₄.

### Example 3

### Preparation of Positive Active Material

Lithium carbonate as a Li raw material, Vanadium (V) Oxide as a V raw material, diammonium phosphate as a PO₄ raw material, and Co nitrate as a Co material were processed in a ball mill. The Co raw material and the V raw material were mixed in a mole ratio of 0.99:0.01 between V and Co atoms included in the raw materials.

The ball mill process was performed for greater than or equal to 48 hours using organic alcohol.

After the ball mill process, the simply-mixed raw materials were heated at about 100° C. under a nitrogen atmosphere or air atmosphere to evaporate the remaining organic alcohol.

After the drying, less than or equal to 5 wt % of sucrose was added to the reactant to coat carbon on the surface thereof.

Then, the reactant was heat-treated at about 700° C. for about 10 hours under a reducing atmosphere, to obtain a positive active material having an average diameter of 200 nm and represented by LiV_{0.99}CO_{0.01}PO₄.

### Example 4

### Preparation of Positive Active Material

Lithium carbonate as a Li raw material, manganese (Mn) oxalate as a Mn raw material, diammonium phosphate as a PO₄ raw material, and Co nitrate as a Co material were processed in a ball mill. The Co raw material and the Mn raw material were mixed in a mole ratio of 0.99:0.01 between Mn and Co atoms included in the raw materials.

The ball mill process was performed for greater than or equal to 48 hours using organic alcohol.

After the ball mill process, the simply-mixed raw materials were heated at about 100° C. under a nitrogen atmosphere or air atmosphere to evaporate the remaining organic alcohol.

After the drying, less than or equal to 5 wt % of sucrose was added to the reactant to coat carbon on the surface thereof.

Then, the reactant was heat-treated at about 700° C. for about 10 hours under a reducing atmosphere, to obtain a positive active material having an average particle diameter of 200 nm and represented by LiMn_{0.99}Co_{0.01}PO₄.

### Example 5

### Preparation of Positive Active Material

Lithium carbonate as a Li raw material, nickel (Ni) oxide as a Ni raw material, diammonium phosphate as a PO₄ raw material, and Co nitrate as a Co material were processed in a ball mill. The Co raw material and the Ni raw material were mixed in a mole ratio of 0.99:0.01 between Ni and Co atoms included in the raw materials.

The ball mill process was performed for greater than or equal to 48 hours using organic alcohol.

After the ball mill process, the simply-mixed raw materials were heated at about 100° C. under a nitrogen atmosphere or air atmosphere to evaporate the remaining organic alcohol.

After the drying, less than or equal to 5 wt % of sucrose was added to the reactant to coat carbon on the surface thereof.

Then, the reactant was heat-treated at about 700° C. for about 10 hours under a reducing atmosphere, to obtain a positive active material having an average particle diameter of 200 nm and represented by LiNi_{0.99}Co_{0.01}PO₄.

### Comparative Example 1

### Preparation of Positive Active Material

Lithium carbonate as a Li raw material, iron oxalate as a Fe raw material, diammonium phosphate as a PO₄ raw material, and Co nitrate as a Co material were processed in a ball mill. The Co raw material and the Fe raw material were mixed in a mole ratio of 0.99:0.01 between Fe and Co atoms.

The ball mill process was performed for greater than or equal to 48 hours using organic alcohol.

After the ball mill process, the simply-mixed raw materials were dried at about 100° C. under a nitrogen atmosphere or air atmosphere to evaporate organic alcohol.

Then, the reactant was heat-treated at about 350° C. for about 5 hours under an air atmosphere to evaporate impurities.

After the drying process, less than or equal to 5 wt % of sucrose was added to the reactant to coat carbon on the surface thereof.

Then, the reactant was heat-treated at about 700° C. for about 10 hours under a reducing atmosphere, to obtain a positive active material having an average particle diameter of 250 nm and represented by LiFe_{0.99}CO_{0.01}PO₄.

### Example 6

### Fabrication of coin cell

### (Fabrication of Positive Electrode)

The positive active material according to Example 1, polyvinylidene fluoride as a binder, and carbon black as a conductive material were mixed in a weight ratio of 90:5:5 in an N-methylpyrrolidone solvent, preparing positive active material layer slurry.

The positive active material layer slurry was coated to be a thin layer on an Al foil as a positive electrode current collector and then, dried at 120° C. for 1 hour and pressed, fabricating a positive electrode including a positive active material layer.

### (Fabrication of Negative Electrodes)

A Li foil as a negative active material was used to fabricate a negative electrode.

(Fabrication of Battery Cells)

The positive electrode, the negative electrode, a 20 μm-thick separator made of a polyethylene material, and an electrolyte solution prepared by mixing EC (ethylene carbonate), EMC (ethylmethyl carbonate), and DMC (dimethyl carbonate) in a volume ratio of 3:3:4 and adding 1.15M LiPF₆ thereto were assembled to fabricate a coin cell.

### Example 7

### Fabrication of Coin Cell

A coin cell was fabricated according to the same method as Example 6 except for using the positive active material of Example 2.

### Comparative Example 2

### Fabrication of Coin Cell

A coin cell was fabricated according to the same method as Example 6 except for using the positive active material according to Comparative Example 1 instead of the positive active material according to Example 1.

### EXPERIMENTAL EXAMPLES

### XRD Analysis

Instrumentation used: X-pert (Philips)

XRD experimental condition:

step size: 0.02 theta

step time: 0.05 seconds

start angle: 10 degrees

end angle: 80 degrees

scan speed: 0.04 μm/s

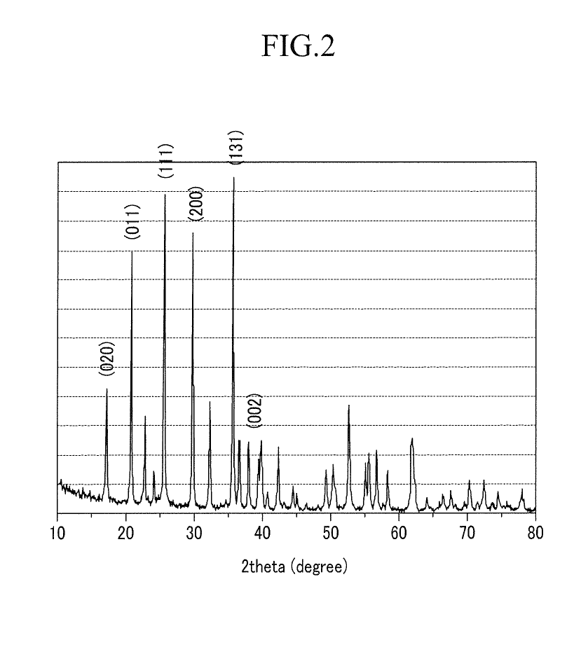

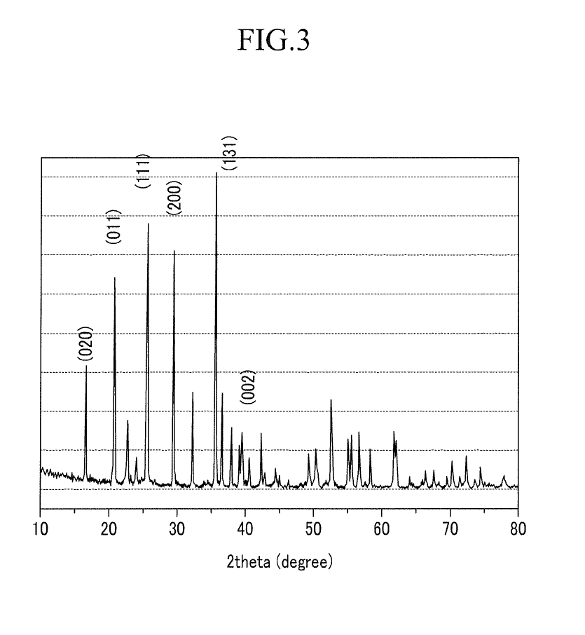

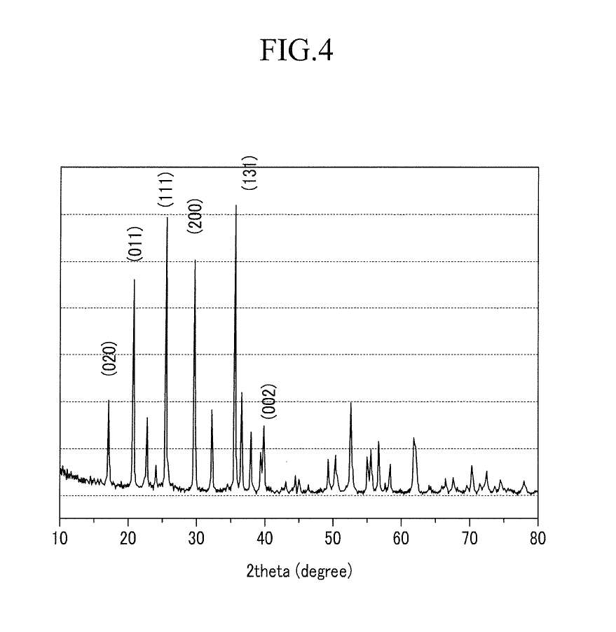

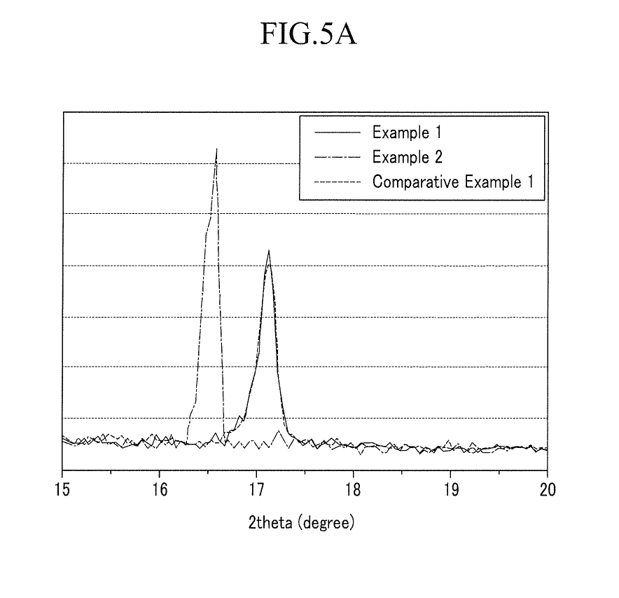

FIG. 2 shows the XRD analysis data of the positive active material according to Example 1, FIG. 3 shows the XRD analysis data of the positive active material according to Example 2, and FIG. 4 shows the XRD analysis data of the positive active material according to Comparative Example 1.

As shown in FIGS. 2 and 3, the positive active materials of Examples 1 and 2 each exhibited a peak at a 2θ value of 40.0 to 41.0 degrees, while Comparative Example 1 did not exhibit a peak at a 2θ value of the same degree range as shown in FIG. 4.

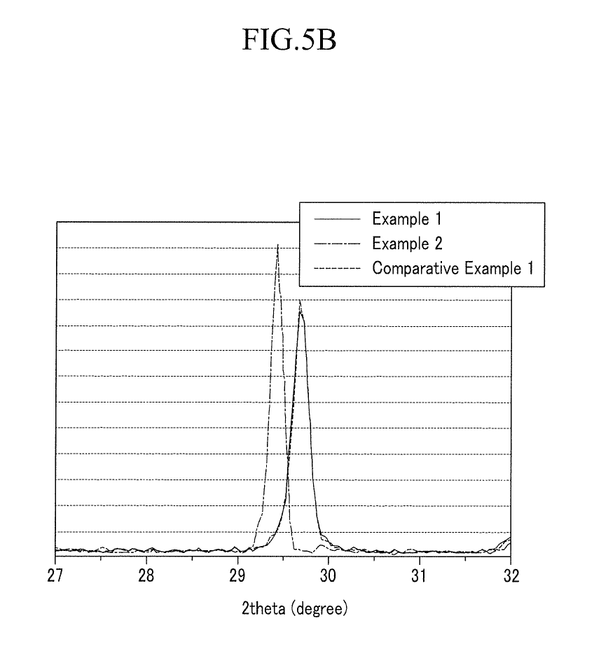

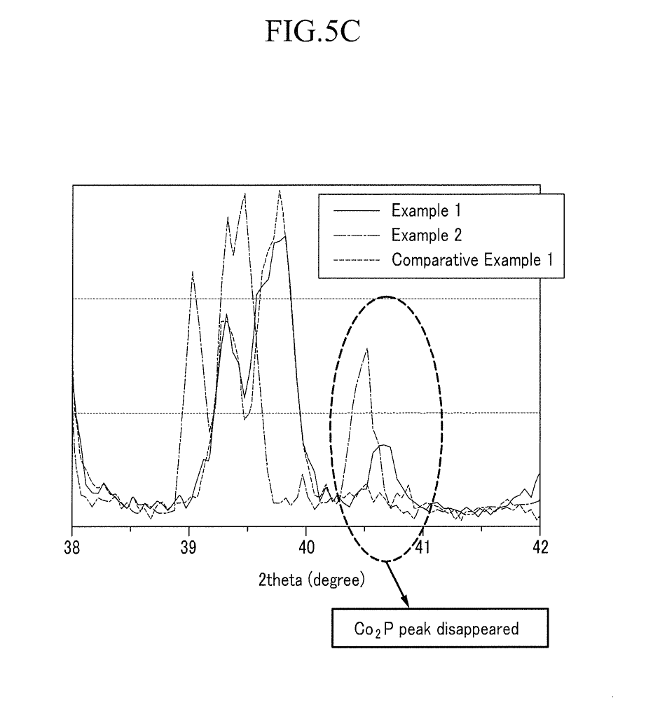

FIGS. 5A, 5B, and 5C show XRD data of each a, b, and c axis direction extracted from the XRD analysis data in FIGS. 2 to 4. The XRD data show that the lattice parameter of an active material changed depending on the heat-treating (e.g., firing) temperature. Herein, a (020) plane refers to a b axis (FIG. 5A), and a (200) plane refers to an a axis (FIG. 5B), and a (002) plane refers to a c axis (FIG. 5C). When the a, b, and c axes of a lattice parameter have a larger change, Li ions more easily move back and forth, improving ion conductivity. Referring to FIGS. 5A, 5B, and 5C, when the heat-treating (e.g., firing) temperature was increased, the resulting particles were larger toward the a and b axis directions. In addition, Comparative Example 1 had no Co₂P peak, when twice heat-treated (e.g., the heat-treatment included multiple steps).

The resultant intensity ratios of XRD peaks at (002) and (020) planes of the XRD patterns of Example 1 and Example 2 from FIGS. 5C and 5A are shown in Table 1. The intensity ratio of XRD peaks at (002) and (020) planes of the XRD patterns can be calculated from the peak intensity values of each XRD peaks at (002) and (020) planes. The peak intensity values of XRD peaks at (002) and (020) planes can be obtained directly from the instrumentation (X-pert, philips). Otherwise, the intensity ratio of XRD peaks can be also obtained from the height ratio of the XRD peaks.

Additionally, electrical conductivity and ion conductivity of the positive active materials prepared in Example 1 and Example 2 are measured and shown in Table 1.

TABLE 1

| | Intensity ratio of | | |
|---|---|---|---|
| | XRD peak at (002) | | |
| | and (020) planes of | Electrical | Ion |
| | the XRD pattern | conductivity | conductivity |
| Example 1 | 8:1 | 10⁻² S/m | 10⁻³ S/m |
| Example 2 | 15:1 | 10⁻² S/m | 10⁻² S/m |

### Battery Cell Characteristics

The coin cells were charged and discharged with a cut-off voltage ranging from 2.0V to 4.2V at a charge and discharge C-rate of 0.1C, 0.2C, 0.5C, 1C, 3C, 5C. All the charge and discharge experiments were performed in a room temperature chamber.

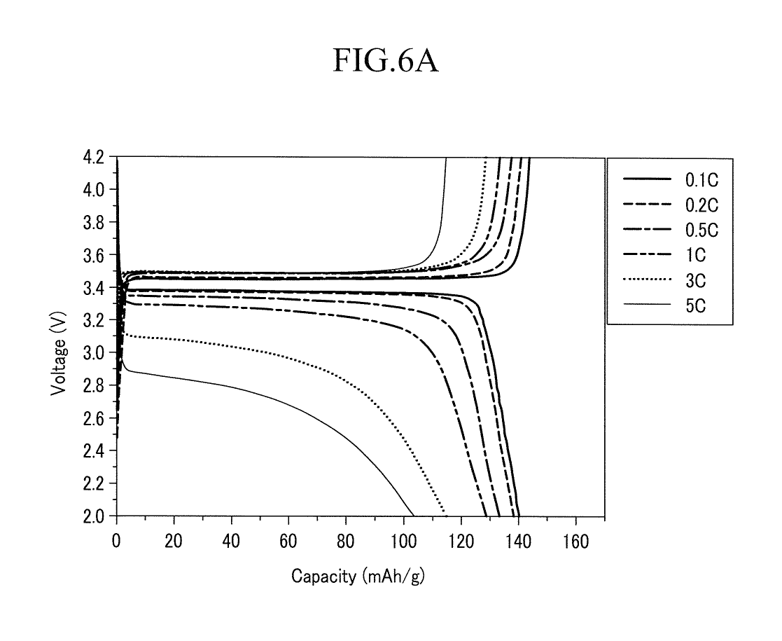

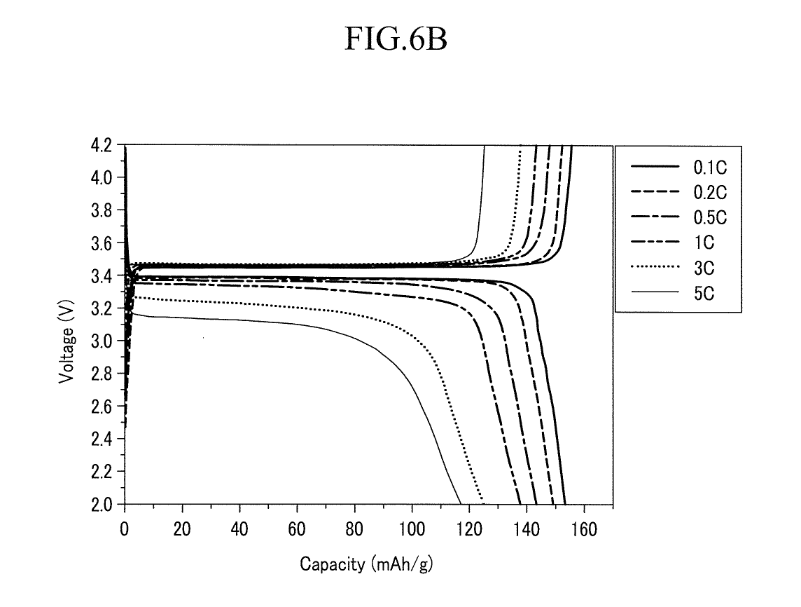

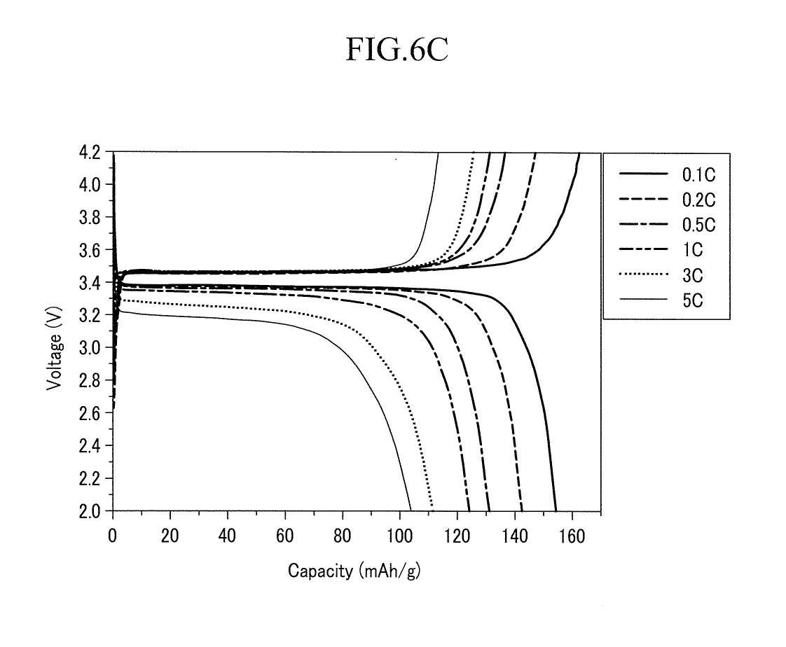

FIGS. 6A through 6C show charge and discharge data of the rechargeable lithium battery cells according to Examples 6 and 7, and Comparative Example 2, respectively.

Example 7 had a higher heat-treating (e.g., firing) temperature than Example 6 and thus, a larger structure toward the a and b axis direction, in which Li ions can be more easily released. As a result, the coin cell of Example 7 had larger capacity at 0.1C. However, since a positive active material had a larger particle at a higher heat-treating temperature and a longer path through which Li ions move back and forth, the coin cell of Example 7 had deteriorated high-rate efficiency characteristics at a higher C-rate compared with the coin cell of Example 6.

On the other hand, the coin cell fabricated through the two heat-treating steps according to Comparative Example 2 had sharply deteriorated initial capacity, because Co₂P, which acts as a conductive layer on the surface, was decomposed and disappeared during the first heat-treating step.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of symbols

| | |
|---|---|
| 100: rechargeable lithium battery | 112: negative electrode |
| 113: separator | 114: positive electrode |
| 120: battery case | 140: sealing member |

What is claimed is:

1. A positive active material for a rechargeable lithium battery comprising a compound according to Chemical Formula 1:
LiₓM_{y}Co_{z}PO₄ Chemical Formula 1
wherein 0≦x≦2, 0.98≦y≦1, 0<z≦0.02, M is selected from the group consisting of V, Mn, Fe, Ni, and combinations thereof, and the compound exhibits a peak at a 2θ value in a range of 40.0 degrees to 41.0 degrees in an X-ray diffraction pattern measured using CuKα radiation.

2. The positive active material of claim 1, wherein the compound exhibits a peak at a (002) plane in the X-ray diffraction pattern and a peak at a (020) plane in the X-ray diffraction pattern, the peak at the (020) plane and the peak at the (002) plane having an intensity ratio in a range of 20:1 to 8:1.

3. The positive active material of claim 1, wherein the compound has an average particle diameter in a range of 100 to 800 nm.

4. The positive active material of claim 1, further comprising a carbon coating layer on at least a portion of the compound.

5. The positive active material of claim 4, wherein the carbon coating layer comprises a carbon material selected from the group consisting of carbon nanotubes, carbon nanorods, carbon nanowires, denka black, ketjen black, and combinations thereof.

6. The positive active material of claim 1, wherein the positive active material has an electrical conductivity in a range of 10⁻⁴² to 10⁻¹ S/m and an ion conductivity in a range of 10⁻¹° to 10⁻¹ S/m.

7. A method of preparing a positive active material, the method comprising:
mixing a Li raw material, an M raw material, a PO₄ raw material, and a Co raw material; and
heat-treating the resultant mixture at a temperature in a range of 650 to 850° C. to prepare a compound according Chemical Formula 1:
LiₓM_{y}Co_{z}PO₄ Chemical Formula 1
wherein 0≦x≦2, 0.98≦y≦1, 0<z≦0.02, M is selected from the group consisting of V, Mn, Fe, Ni, and combinations thereof.

8. The method of claim 7, wherein the heat-treating comprises increasing the temperature at a rate of 2° C./min.

9. The method of claim 7, wherein the heat-treating is performed for 10 hours.

10. The method of claim 7, further comprising cooling the compound.

11. The method of claim 10, wherein the cooling comprises decreasing the temperature at a rate of 2° C./min.

12. The method of claim 7, further comprising adding a carbon raw material to the resultant mixture prior to the heat-treating.

13. The method of claim 12, wherein the carbon raw material is selected from the group consisting of sucrose, glycol, glycerin, kerosene, and combinations thereof.

14. The method of claim 7, wherein the heat-treating is performed as a single step.

15. A rechargeable lithium battery comprising:
a positive electrode comprising a positive active material comprising a compound according to Chemical Formula 1
LiₓM_{y}Co_{z}PO₄ Chemical Formula 1
wherein 0≦x≦2, 0.98≦y≦1, 0<z≦0.02, M is selected from the group consisting of V, Mn, Fe, Ni, and combinations thereof, and the compound exhibits a peak at a 2θ value in a range of 40.0 degrees to 41.0 degrees in an X-ray diffraction pattern measured using CuKα radiation;
a negative electrode comprising a negative active material and facing the positive electrode; and
an electrolyte between the positive electrode and the negative electrode.

16. The rechargeable lithium battery of claim 15, wherein the compound exhibits a peak at a (002) plane in the X-ray diffraction pattern and a peak at a (020) plane in the X-ray diffraction pattern, the peak at the (020) plane and the peak at the (002) plane having an intensity ratio in a range of 20:1 to 8:1.

17. The rechargeable lithium battery of claim 15, wherein the compound has an average particle diameter in a range of 100 to 800 nm.

18. The rechargeable lithium battery of claim 15, further comprising a carbon coating layer on at least a portion of the compound.

19. The rechargeable lithium battery of claim 18, wherein the carbon coating layer comprises a carbon material selected from the group consisting of carbon nanotubes, carbon nanorods, carbon nanowires, denka black, ketjen black, and combinations thereof.

20. The rechargeable lithium battery of claim 15, wherein the positive active material has an electrical conductivity in a range of 10⁻⁴² to 10⁻¹ S/m and an ion conductivity in a range of 10⁻¹⁰ to 10⁻¹ S/m.
